(19) United States
(12) Patent Application Publication
(10) Pub. No.: US 2025/0258301 A1
(43) Pub. Date: Aug. 14, 2025

(54) HYBRID ARCHITECTURE FOR TRACEABLE TIMING SERVICES

(71) Applicant: NextNav, LLC, Sunnyvale, CA (US)

(72) Inventors: Cristina SEIBERT, Mountain View, CA (US); Arun RAGHUPATHY, Ramagondanahalli, Whitefield, Bangalore (IN)

(73) Assignee: NextNav, LLC, Sunnyvale, CA (US)

(21) Appl. No.: 18/631,154

(22) Filed: Apr. 10, 2024

Related U.S. Application Data
(60) Provisional application No. 63/495,367, filed on Apr. 11, 2023.

(51) Int. Cl. G01S 19/25

(52) U.S. Cl. CPC G01S 19/256

(57) ABSTRACT

Method includes receiving a first delay time and a first timing measurement by a TMV from a first receiver at a first node. The first timing measurement is generated by comparing a first time associated with a first signal to a first local clock time. The first signal is transmitted by a transmitter at a source. The TMV receives from a second receiver at a second node in a network, a second delay time and a second timing measurement. The second timing measurement is generated by comparing a second time associated with a second signal to a second local clock time. The second signal is transmitted by the transmitter at the source. The TMV generates a correction factor time based on the first timing measurement, the first delay time, the second timing measurement, and the second delay time. The TMV transmits the correction factor time to the second node.

### RELATED APPLICATIONS

This application claims priority to U.S. Provisional Patent Application No. 63/495,367 filed on Apr. 11, 2023, which is hereby incorporated by reference in full.

### BACKGROUND

Determining the exact location of a mobile device (e.g., a phone, laptop computer, tablet, or another device) in an environment can be quite challenging, especially when the mobile device is located in an urban environment or is located within a building. Imprecise estimates of the mobile device's position may have “life or death” consequences for the user. For example, an imprecise position estimate of a mobile device, such as a mobile phone operated by a user calling 911, can delay emergency personnel response times. In less dire situations, imprecise estimates of the mobile device's position can negatively impact navigation applications by directing a user to the wrong location or taking too long to provide accurate directions.

Multilateration is a widely used technique to determine the position of a mobile device. This is achieved by measuring the time delay or signal strength from multiple known points, such as satellites in Global Navigation Satellite Systems (GNSS) or cell towers. As mentioned above, the accuracy and reliability of location estimation are critical, especially in applications like navigation, emergency services, and location-based services.

Coordinated Universal Time or Universal Time Coordinated (UTC) is the official, internationally agreed upon standard for world time. The National Institute of Standards and Technology (NIST) maintains its own representation of UTC, which serves as the official time standard for the United States. Timing services with traceability to a country's sovereign time and/or time scales, such as UTC, are desirable or sometimes required in many industry sectors. The industry sectors may include critical infrastructure such as energy power grids, financial services, and business markets. The NIST Time Measurement and Analysis Service (TMAS) monitors a customer's local time standard by continuously comparing it to UTC and reports new results, for example, via the Internet, to the customer at certain time intervals, such as every 10 minutes.

It is known in the art that traceable timing services may be expensive as they require access to absolute sources of time, such as those provided by NIST in the United States. Timing distribution is traditionally done using a form of satellite time transfer and can easily transfer time over long distances. For example, GPS (or GNSS) system time is related to UTC time and may be transferred to a remote site which has a GPS receiver that extracts timings from the signal. Other satellite-based time transfer methods include Two-Way Satellite Time Transfer (TWSTT) in the US, where a custom waveform and modem are used to transfer time very accurately through a satellite. Another time transfer method may be through optical fiber. The timing distribution could be via dark fiber, dedicated wavelengths allocated to customers using the timing service, or through re-using just packet data fiber links. Each medium for time transfer provides different grades of performance. Although expensive, using fiber services for time distribution reduces exposure to satellite-based time transfer vulnerabilities, such as open-air or wireless jamming and spoofing attacks.

### SUMMARY

A method is disclosed and includes a timing validation service (TMV) receiving a first delay time and a first timing measurement from a first receiver at a first node. The first timing measurement is generated by comparing a first time associated with a first signal to a first local clock time associated with the first node. The first signal is of a plurality of signals transmitted by a transmitter at a source. Each signal of the plurality of signals has an associated time. The TMV receives a second delay time and a second timing measurement from a second receiver at a second node of a plurality of nodes in a network. The second timing measurement is generated by comparing a second time associated with a second signal to a second local clock time at the second node. The second signal is of the plurality of signals transmitted by the transmitter at the source. The TMV generates a correction factor time based on the first timing measurement, the first delay time, the second timing measurement, and the second delay time. The TMV transmits the correction factor time to the second node.

### BRIEF DESCRIPTION OF THE DRAWINGS

FIG. 1 is an operational environment for traceable timing services using a hybrid architecture, in accordance with some embodiments.

FIG. 2 is a schematic of a position, navigation, and timing (PNT) network, in accordance with some embodiments.

FIG. 3 is a flowchart for a method for traceable timing services, in accordance with some embodiments.

FIG. 4 is a flowchart for a method for determining an anomalous condition, in accordance with some embodiments.

FIG. 5 is a schematic of a communication topography for nodes in a position, navigation, and timing (PNT) network, in accordance with some embodiments.

FIG. 6 is a schematic for a two-way time transfer method for nodes in a position, navigation, and timing (PNT) network, in accordance with some embodiments.

FIG. 7 is a schematic of a position, navigation, and timing (PNT) network with a timing validation service (TMV) at every node, in accordance with some embodiments.

FIG. 8 is a schematic of a position, navigation, and timing (PNT) network with a timing validation service (TMV) at two leader nodes, in accordance with some embodiments.

FIG. 9 provides implementation details of an example transmitter, mobile device, and server introduced in FIG. 1, in accordance with some embodiments.

### DETAILED DESCRIPTION

Systems and methods disclosed herein provide traceable timing services to sovereign time with a hybrid architecture having a plurality of nodes in a network. The network may be a position, navigation, and timing (PNT) network with a hybrid architecture providing traceable timing services to optimize deployment and cost, while minimizing exposure to vulnerabilities. The nodes are geographically separated nodes, and some nodes in a timing network may depend on costly methods like dedicated fiber links, while other nodes may primarily rely on more affordable solutions, such as those based on common-view satellites. Within the network, some nodes may have access to fiber, while other nodes may depend on a timing validation service (TMV). In specific embodiments, nodes could utilize a combination of existing fiber access and timing services.

Nodes with access to a multiplicity of timing sources may analyze the characteristics of the timing measurements and data dynamically. Such analysis may validate a time or detect an anomaly or erroneous condition pertaining to timing sources that may be relied on by nodes in the network. This anomaly may be flagged as a potential issue and communicated to other nodes, users, and customers. When the anomaly is detected, the nodes may stop using the affected timing source and instead use an alternative timing source when available.

In some embodiments, a beacon may be equipped with a TMV and multiple timing sources. The TMV may identify anomalies in timing sources and invalidate the source that provides timing information inconsistent with timing measurements. This beacon can then notify other nodes in the network relying on the same source to disregard its provided timing information due to the detected anomaly. Essentially, a first beacon with multiple timing sources and a TMV can recognize irregularities in timing signals, for instance, and relay instructions to a second beacon lacking a TMV but sharing the same timing sources, prompting the second beacon to disregard timing information data.

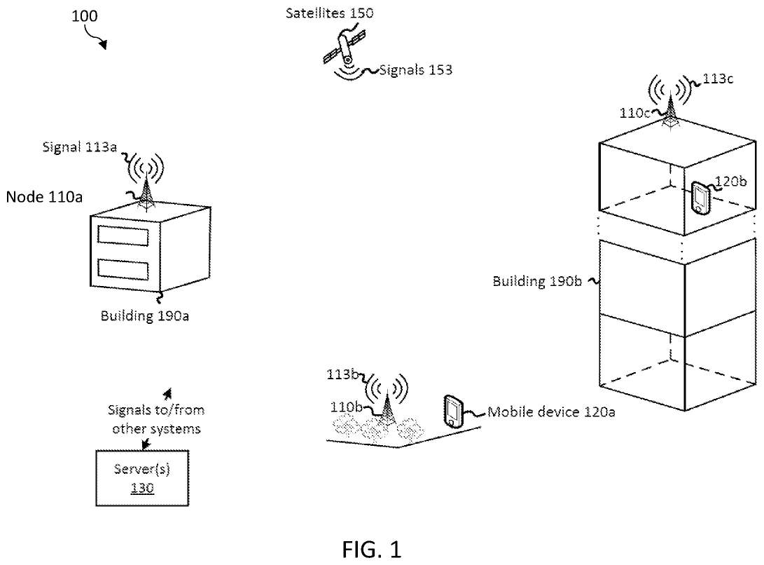

Attention is initially drawn to an operational environment 100 for traceable timing services, such as for when determining an estimated position of a mobile device, in FIG. 1. FIG. 1 is an operational environment for traceable timing services using a hybrid architecture, in accordance with some embodiments. The operational environment 100 contains a network of nodes 110a-c, any number of mobile devices 120a-b, any number of buildings 190a-b, any number of satellites 150, and any number of servers 130. The nodes 110a-c may be beacons, terrestrial transmitters, and/or transceivers. Also shown are ranging signals 113a-c associated with the respective nodes 110a-c, and ranging signals 153 associated with the satellites 150.

The nodes 110a-c and the mobile devices 120a-b may be located at different altitudes or depths that are inside or outside various natural or manmade structures (e.g., the buildings 190a-b). The signals 113a-c and 153 are exchanged between the mobile devices 120a-b, the nodes 110a-c, and the satellites 150 using known wireless or wired transmission technologies. The nodes 110a-c may transmit the signals 113a-c using one or more common multiplexing parameters—e.g., time slot, pseudorandom sequence, or frequency offset. The servers 130 and the mobile devices 120a-b may exchange information with each other.

The satellites 150 may be part of a GNSS (Global Navigation Satellite System) which may include other existing satellite positioning systems such as Glonass as well as future positioning systems such as Galileo and Compass/Beidou. The nodes 110a-c may be synchronized beacons of a wide area positioning system and may form a CDMA network. Each of the nodes 110a-c may be operable to transmit a Pseudo Random Number (PRN) sequence with good cross-correlation properties such as a Gold Code sequence with a data stream of embedded assistance data. Alternatively, wireless signals transmitted by the nodes 110a-c may be staggered in time into separate slots in a Time Division Multiple Access (TDMA) format. The mobile devices 120a-b are operable to receive ranging signals using a wireless position signal receiver and to determine an estimated timing solution, and optionally 2D or 3D position thereof based on time of arrival estimates of the received signal using multilateration techniques.

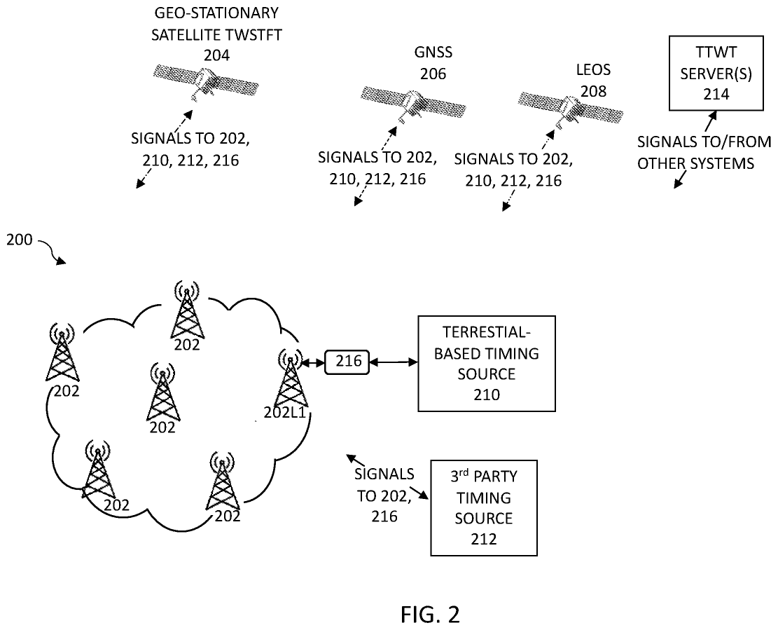

FIG. 2 is a schematic of a position, navigation, and timing (PNT) network, in accordance with some embodiments. A network 200 includes a network build-out for a wide area coverage of the purpose-built terrestrial PNT system. In an example network build and system option, the network 200 configuration is a resilient PNT solution using a dedicated network of a plurality of nodes. The plurality of nodes may be at least terrestrial PNT beacons 202 of a terrestrial positioning network which are part of a system for traceable timing services. The terrestrial PNT beacon may be referred to as beacon 202 singularly or as beacons 202 collectively. Each beacon 202 includes a terrestrial PNT receiver (referred to as receiver) and a local clock, among other components. The local clock is a physical hardware register device. In some embodiments, there may be one or more leader terrestrial PNT beacons 202L1 (or 202L2, 202L3 . . . 202Ln) that are in communication with the other beacons 202, known as follower beacons, in the network 200. In a particular network 200, more than one leader beacon may be included for redundancy and additional resiliency against failure of one leader beacon. In some embodiments, the beacons 202 may implement, or be included as part of, the nodes 110 shown and described with reference to FIG. 1.

In other embodiments, the plurality of nodes may be, or include, listening devices or Signal Monitoring Units (SMUs) (not shown) that are operable to receive timing synchronization information. This may include location monitoring units (LMUs), timing monitoring units (TMUs), or other signal monitoring devices known in the art. In this context, the terms “listen” and “hear” mean to receive and process signals (such as cellular signals, Wifi signals, Bluetooth® signals, etc.). A listening device, as disclosed herein, is a signal receiver or scanner unit that is deployed within a region in order to determine and track critical parameters of received signals, such as timing differences. The SMUs may monitor and estimate the timing signal as disclosed in U.S. application Ser. No. 18/495,490, which is incorporated herein in its entirety for all purposes.

The nodes or beacons 202 in the network 200 may receive signals through the receiver from various sources, such as a geo-stationary satellite 204, a Global Navigation Satellite System (GNSS) 206 including GPS, GLONASS, Galileo, and Compass/Beidou, and a Low-Earth Orbiting Satellite (LEOS) 208. In some embodiments, the receiver of the beacon 202 may be a User Equipment (UE) timing receiver. In some embodiments, a third-party timing source 212 may also provide a timing to the beacons 202. This may be a subscription-based paid service from a high precision timing source employing dark fiber for data transmissions. This scenario may be used across diverse sectors such as finance, telecommunications, computer networks, and scientific research. In some embodiments, the satellites 204, 206, and 208 may implement the satellites 150 shown and described with reference to FIG. 1.

A terrestrial-based timing source 210 receives a plurality of signals and each signal of the plurality of signal has an associated time. The plurality of signals are received from various sources, such as the geo-stationary satellite 204 and GNSS 206, and provides the associated time of the signal on the common time scale or standard time scale such as UTC. Depending on location, UTC is maintained by a local organization such as NIST in the United States, the Bureau International des Poids et Mesures (BIPM) in France, and the National Time Service Center (NTSC) in China. The terrestrial-based timing source 210 provides timing associated with a common or standard time scale distributed through fiber, dark fiber, satellites, or other means.

Timing information may be conveyed to the nodes (e.g., beacons 202) using signals in common view. In this context, common view is when two or more different beacons receive the same signal from a given transmitter. The signals in common view can be any signal that has a time signature (i.e., pre-defined points on the waveform which are transmitted at specific times relative to a local time scale) embedded in the signal waveform, and for which the location from which the signal is transmitted is known. Time of arrival (TOA) measurements of the common view signals on the respective local time scales for a plurality of beacons 202 can be exchanged. The measurements exchanged can optionally, include a frequency offset measurement as well. After removing the time corresponding to the distance between the common view source and beacons, time corrections for the local time scale of each beacon 202 can be derived relative to an arbitrary common time scale. Examples of such common view signals include satellite signals such as geo-stationary satellite 204, GNSS 206, and LEOS 208.

A Two-way Time Transfer (TWTT) server 214 manages a two-way time transfer method for synchronizing signals of the network 200 to determine a common time scale in an optimal manner. The TWTT server 214 communicates with the beacons 202 of the purpose-built terrestrial PNT system—the network 200—and receives time transfer measurements from each beacon 202 corresponding to all other beacons 202 it can listen to or hear. In some embodiments, the network 200 is designed in a manner that maximizes the listening capability of each beacon 202 to enable resiliency and redundancy. For example, the design may be constructed in such a manner that at least two or more beacons 202 are hearable from every beacon 202 to enable time transfer capability availability. This redundancy allows for continuous time transfer capability, even if one beacon 202 fails. For the two-way time transfer method, the TWTT server 214 provides time synchronization adjustments for the beacons 202 to control their local clocks. Alternatively, these corrections can serve as timing adjustments when utilizing signals from beacons 202.

A Timing Validation Service (TMV) 216L1 evaluates the accuracy and precision of timekeeping devices, such as clocks and oscillators, by comparing their measurements to a reference standard. The TMV 216 may advantageously receive signals through a receiver from any source such as the geo-stationary satellite 204, GNSS 206 (including GPS, GLONASS, Galileo, Compass/Beidou), LEOS 208, terrestrial-based timing source 210, and third-party timing source 212.

It is known in the art that the NIST Time Measurement and Analysis Service (TMAS) is a service that evaluates the accuracy and precision of their timekeeping devices. However, NIST TMAS only utilizes a subset of the available satellites for timing information. Namely, NIST TMAS only uses a GPS satellite signal for timing information. In the present disclosure, the TMV 216 can use timing signals from a variety of sources such as geo-stationary satellite 204, GNSS 206 (including GPS, GLONASS, Galileo, Compass/Beidou), LEOS 208, and third-party timing source 212. This provides the TMV 216 with greater diversity compared to TMAS in terms of the satellites it can reference for correction to a traceable sovereign time. The TMV 216 can synchronize with a variety of timing sources to achieve sovereign time. Moreover, because the TMV 216 can use timing signals from a variety of sources rather than only GPS, there is inherent redundancy. For example, GPS spoofing involves transmitting false GPS signals to deceive GPS receivers into providing incorrect information. If this occurs, the present embodiments enable the beacon 202 to determine an anomaly due to spoofing (as well as due to other scenarios), disregard the signal, and use an alternative source for the timing information.

Referring to FIG. 2, the TMV 216L1 is in communication with the network 200 through the leader beacon 202L1 for providing traceable timing services. The link can utilize fiber-optic or dark fiber connections. Despite being costly, leveraging fiber services for time dissemination mitigates risks associated with satellite-based time transfer vulnerabilities, such as susceptibility to open-air or wireless jamming, and spoofing attacks. The hybrid architecture takes advantage of fiber services at only one node, the leader beacon, while the other beacons 202 in the network 200 rely on other more affordable solutions, such as those based on common-view satellites.

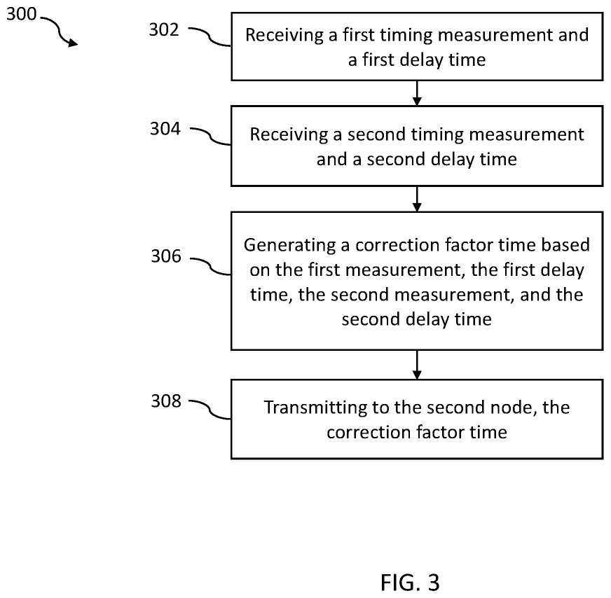

FIG. 3 is a flowchart for a method for traceable timing services, in accordance with some embodiments. The particular steps, order of steps, and combination of steps are shown for illustrative and explanatory purposes only. Other embodiments can implement different particular steps, orders of steps, and combinations of steps to achieve similar functions or results. A method 300 provides traceable timing services. At block 302, the TMV 216 receives a first timing measurement and a first delay time. For example, the terrestrial-based timing source 210 is a first node having a first receiver and a first local clock. The first receiver receives a first signal of a plurality of signals from a transmitter at a source, and the first signal has an associated first time. The source may be the geo-stationary satellite 204, GNSS 206, LEOS 208, or third-party timing source 212. The first time associated with a first signal is compared to the first local clock time associated with the terrestrial-based timing source 210 (e.g., the first node) and a first timing measurement is generated and denoted herein as Ma.

The first delay time, denoted herein as dA, is a first propagation delay based on a position of the transmitter at the source and a position of a first receiver antenna at the terrestrial-based timing source 210 (e.g., the first node). A processing delay time and an implementation delay time may be included to account for a delay for the signal passing through the ionosphere and troposphere on its way to the Earth's surface, a multipath signal reflection, antenna cable, receiver processing delays, and other implementation factors.

At block 304, the TMV 216 receives a second timing measurement and a second delay time. For example, the leader beacon 202L1 is a second node of a plurality of nodes in the network 200 having a second receiver and a second local clock. The second receiver receives a second signal of a plurality of signals from a transmitter at a source, and the second signal has an associated second time. The source may be the geo-stationary satellite 204, GNSS 206, LEOS 208, or third-party timing source 212. The second time associated with a second signal is compared to the second local clock time at the leader beacon 202L1 (e.g., the second node) and a second timing measurement is generated, denoted herein as Mb.

The second delay time, denoted herein as dB, is a second propagation delay based on a position of the transmitter at the source and a position of a second receiver antenna at the leader beacon 202L1 (e.g., the second node). A processing delay time and an implementation delay time may be included to account for a delay for the signal passing through the ionosphere and troposphere on its way to the Earth's surface, a multipath signal reflection, antenna cable, receiver processing delays, and other implementation factors.

At block 306, the TMV 216 generates a correction factor time based on the first timing measurement, the first delay time, the second timing measurement, and the second delay time. In some embodiments, the correction factor time may be generated as shown below.

Correction=(Ma−Mb)+(dA−dB) Equation 1

At block 308, the TMV 216 transmits the correction factor time to the leader beacon 202L1 (e.g., the second node). The correction factor time represents an amount of time that the second local clock differs from the terrestrial-based timing source 210. The terrestrial-based timing source 210 is considered to provide accurate time and is therefore used as a reference for networks to synchronize their clocks or devices to this time. In some embodiments, the correction factor time is applied to the second local clock to adjust its time to synchronize to sovereign time. In this way, after applying the correction factor time to the second local clock, the second local clock is aligned with absolute time.

In some embodiments, the hybrid architecture of the network 200 may estimate the position of a mobile device 120 as shown in FIG. 1 (e.g., a mobile device, smartphone, cell phone, computer, game console, smart watch, etc.). The network 200 in the present embodiments is a hybrid PNT system, and for simplicity or convenience of description, it is understood that the system can determine any combination of one or more of position, navigation, and timing.

As described with reference to FIG. 1, the mobile devices 120a-b are operable to receive ranging signals using a wireless position signal receiver and to determine an estimated 2D or 3D position thereof based on time of arrival estimates of the received signal using multilateration techniques. In some embodiments, a first estimated position of a mobile device is determined by a server and/or the mobile device using the signals 113a-c and/or 153 as received and before applying the correction factor time to the signals. For example, the first estimated position of a mobile device is determined based on timing signals that are not synchronized to absolute time. After method 300 is performed and the local clocks apply the correction factor time thereby synchronizing to absolute time, a second estimated position of a mobile device is determined by a server and/or the mobile device using the signals 113a-c and/or 153. Stated differently, in some embodiments, a first estimated position of a mobile device is determined before the adjusting of the second local clock time with the correction factor time. The second estimated position of the mobile device is determined after the adjusting of the second local clock time with the correction factor time.

When comparing the second estimated position to the first estimated position of the mobile device, the second estimated position is a more accurate position than the first position estimate of the mobile device. For, example, the first estimated position of the mobile device relies on timing signals that may be offset from an accurate time, and/or may not be synchronized in time to the other beacons 202. After performing the method 300 and applying the correction factor time to the local clocks, the second estimated position of the mobile device is determined. Because the time is now synchronized, using the second estimated position is a more accurate position estimate as compared to the first position estimate of the mobile device.

The plurality of nodes (e.g., beacons 202) in the network 200 have access to multiple timing sources (e.g., the geo-stationary satellite 204, GNSS 206, LEOS 208, terrestrial-based timing source 210, and third-party timing source 212) and are configured to analyze the characteristics of the timing measurements and/or data dynamically. From the analysis, anomalies may be detected associated with the timing source that is relied on by the beacons 202 in the timing system of the network 200. In some embodiments, the correction factor time may be used to determine an anomaly in the signal from the source.

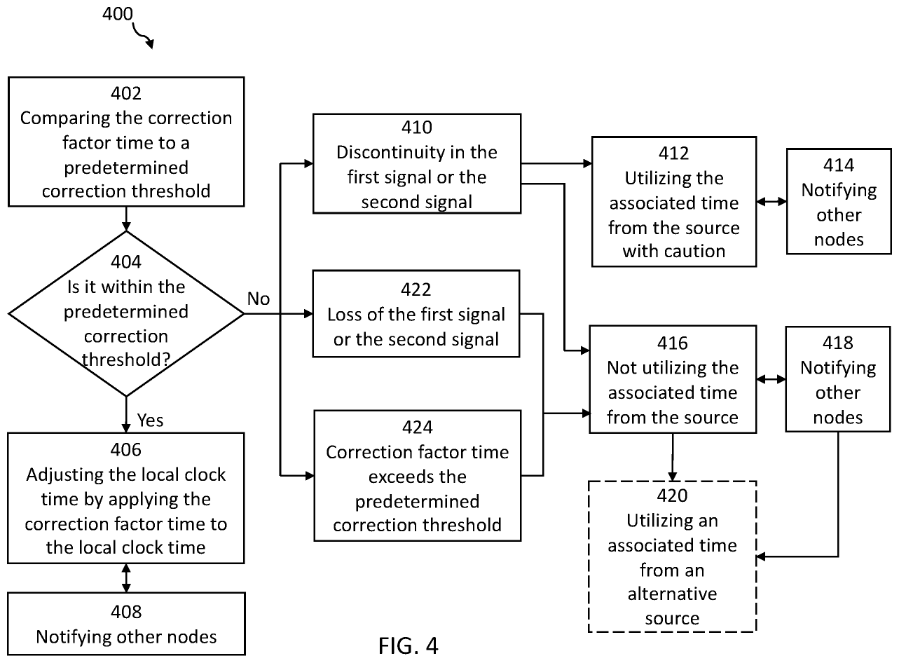

FIG. 4 is a flowchart for a method for determining an anomalous condition, in accordance with some embodiments. The particular steps, order of steps, and combination of steps are shown for illustrative and explanatory purposes only. Other embodiments can implement different particular steps, orders of steps, and combinations of steps to achieve similar functions or results. A method 400 for determining an anomalous condition may detect an anomaly pertaining to timing signals or sources that may be relied on by the plurality of nodes (e.g., beacons 202) in the network 200.

The anomaly may be a discontinuity in the second signal, a loss of the second signal, or the correction factor time exceeding a predetermined correction threshold. For example, GPS spoofing, or a jamming event, may be detected which may affect the nodes in the network 200 relying on GPS and/or another timing source.

At block 402, the correction factor time generated as described in method 300 is compared to a predetermined correction threshold. At block 404, it is determined if the correction factor time is within the predetermined correction threshold. In some embodiments, the predetermined correction threshold may be a range of 0±5 nanoseconds or 0±10 nanoseconds as compared to the sovereign time. If yes, then no anomaly is present and, at block 406, the second receiver adjusts the second local clock time by applying the correction factor time to the second local clock time. This synchronizes the second local clock to sovereign time. At block 424, the second receiver may notify a third receiver at a third node of the plurality of nodes in the network via a side communication channel or via a beacon data transmission of the correction factor time. As such, the third receiver may then decide how to use the information such as at block 408, applying a correction factor time to the third local clock time at the third node. In further embodiments, after applying the correction factor time to the second local clock time, the second time is validated. When the second time is validated, the beacon may have confidence in the integrity of the source and continue to use the provided signals from the source.

At block 410, the anomaly may be a discontinuity in the second signal. The discontinuity such as a step function refers to a sudden change or jump in the data being analyzed. Specifically, a step function represents a sharp transition from one value to another without any intermediate values. This may be due to a sudden increase or decrease in a signal, or a discontinuous event, and further analysis is performed to understand the behavior of the system. Based on the analysis and in response to the anomaly being the discontinuity in the second signal, at block 412, the associated time of the plurality of signals from the source is utilized by the second receiver with caution. In this context, “with caution” means to de-prioritize or de-weight a particular signal and/or solution, for example, such as when combining the signal with other signals and/or solutions to arrive at an aggregate, ensemble solution. At block 414, the second receiver may notify a third receiver at a third node of the plurality of nodes in the network via a side communication channel or via a beacon data transmission of the anomaly. The third receiver may then decide how to use the information such as at block 412, utilizing the associated time of the plurality of signals from the source with caution.

In other embodiments, based on the analysis and in response to the anomaly being the discontinuity in the second signal, at block 416, the associated time of the plurality of signals from the source is not utilized by the second receiver. At block 418, the second receiver may notify a third receiver at a third node of the plurality of nodes in the network via a side communication channel or via a beacon data transmission of the anomaly. The third receiver in common view with the second receiver may at block 416, not utilize the associated time of the plurality of signals from the same source due to the anomaly.

Optionally, at block 420, when the second receiver or the third receiver does not utilize the associated time of the plurality of signals from the source, the second receiver or the third receiver may utilize an associated time of the plurality of signals from an alternative transmitter at an alternative source. As such, the alternative transmitter is configured to transmit the plurality of signals to the second receiver or the third receiver respectively. Put another way, if the discontinuity in the second signal is of concern, the second receiver may use the signal from an alternative source. In some embodiments, the alternative source is a highly stable, precise timing source or a two-way time transfer method. The highly stable, precise timing source may be an atomic clock (e.g., rubidium or cesium), hydrogen maser clock, optical clock or quartz crystal oscillator. Regarding the third receiver, once the second node communicates the anomaly in the common source, the third receiver may use the signal from an alternative source. In some embodiments, the alternative source is the highly stable, precise timing source or a two-way time transfer method.

At block 422, the anomaly may be a loss of the second signal. This may occur due to inclement weather such as a storm where the timing signal (e.g., the second signal) is unable to reach the receiver. In another example, the loss of the second signal may occur during a disruption such as a local jamming event. In response to the anomaly being the loss of the second signal, at block 416, the associated time of the plurality of signals from the source is not utilized by the second receiver. At block 418, the second receiver may notify a third receiver at a third node of the plurality of nodes in the network via a side communication channel or via a beacon data transmission of the anomaly. The third receiver in common view with the second receiver may at block 416, not utilize the associated time of the plurality of signals from the same source due to the anomaly.

When the second receiver does not utilize the associated time of the plurality of signals from the source, then optionally at block 420, the second receiver may utilize an associated time of the plurality of signals from an alternative transmitter at an alternative source. Similarly, once the second node communicates the anomaly in the common source to the third receiver, the third receiver may use the signal from an alternative source. In some embodiments, the alternative source is a highly stable, precise timing source or a two-way time transfer method.

At block 424, the anomaly may be that the correction factor time exceeds the predetermined correction threshold. This may occur during a data or measurement spoofing event where the receiver is processing a signal generated by a bad actor in lieu of the authentic signal. At block 416, as described herein, the second receiver does not utilize the associated time of the plurality of signals from the source, and may at block 418, notify the plurality of nodes in the network 200 such as a third node. At block 420, the second receiver may utilize an associated time from an alternative source. As described herein, based on the notification of the anomaly from the second node, the third node may also utilize an associated time from an alternative source.

In some embodiments, the systems and methods for traceable timing services disclosed herein may use a variety of timing sources and combinations and can be applied to timing systems beyond terrestrial positioning networks. For example, the behavior exhibited under a threat, hazard, or disruption (THD) event may be unique to each timing source used in the timing system. Embodiments disclosed herein advantageously enable isolation of the timing solution affected by the THD event. Responsive actions suitable to the anomalous condition detected may be taken by the timing system.

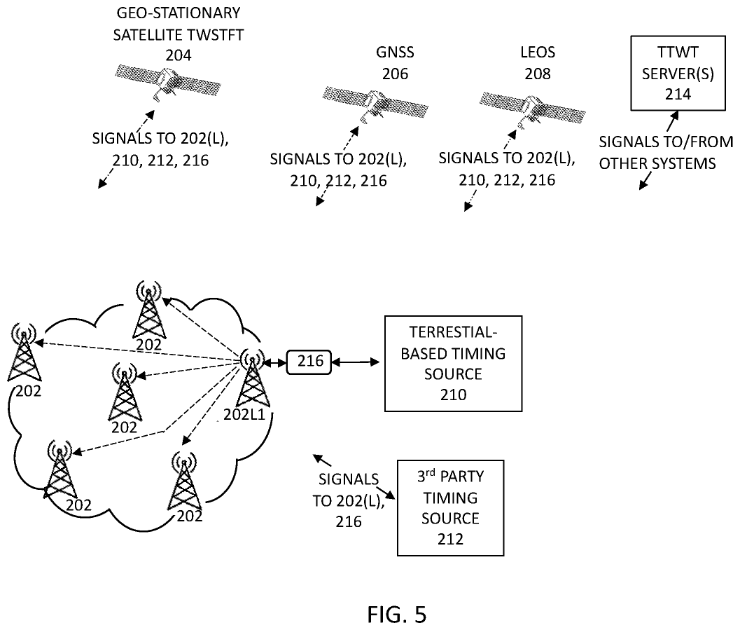

FIG. 5 is a schematic of a communication topography for nodes in a position, navigation, and timing (PNT) network, in accordance with some embodiments. In the network 200, the leader beacon 202L1 is in communication with the plurality of nodes in the network 200. The communication is represented by arrows. This may be accomplished, for example, through a side communication channel or through beacon data transmissions. When the anomaly or anomalous condition is detected, the plurality of nodes (e.g., beacons 202) in the network 200 may be notified by the leader beacon 202L1. Consequently, the plurality of nodes may not utilize the signal from the affected timing source (see FIG. 4, block 416) or the plurality of nodes may disengage from using the affected timing source. In some embodiments, the nodes no longer using the affected timing source, may switch to an alternative timing source (see FIG. 4, block 418) and utilize the signals from the alternative timing source. The alternative timing source may be a highly stable, precise timing source that is not disciplined by satellite. In some embodiments, the nodes (e.g., beacons 202) are in communication with users or customers in the network 200 of the timing system. When the anomaly or anomalous condition is detected, the node may report the anomaly to users or customers in the network 200.

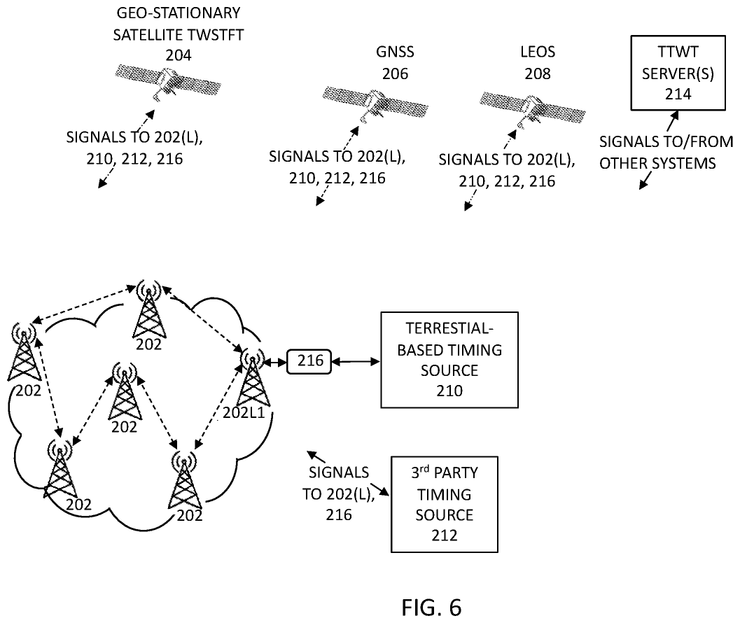

FIG. 6 is a schematic for a two-way time transfer method for nodes in a position, navigation, and timing (PNT) network, in accordance with some embodiments. The alternative timing source may utilize a two-way time transfer method between wireless transmission points such as those used in the terrestrial positioning network. For example, the two-way time transfer method may be used when a node is within sufficient proximity to a beacon 202 of a terrestrial positioning network having fiber timing access. The two-way time transfer method synchronizes the timing of the beacons 202 of the network 200 using a leader-follower topology to maintain UTC at each terrestrial beacon 202.

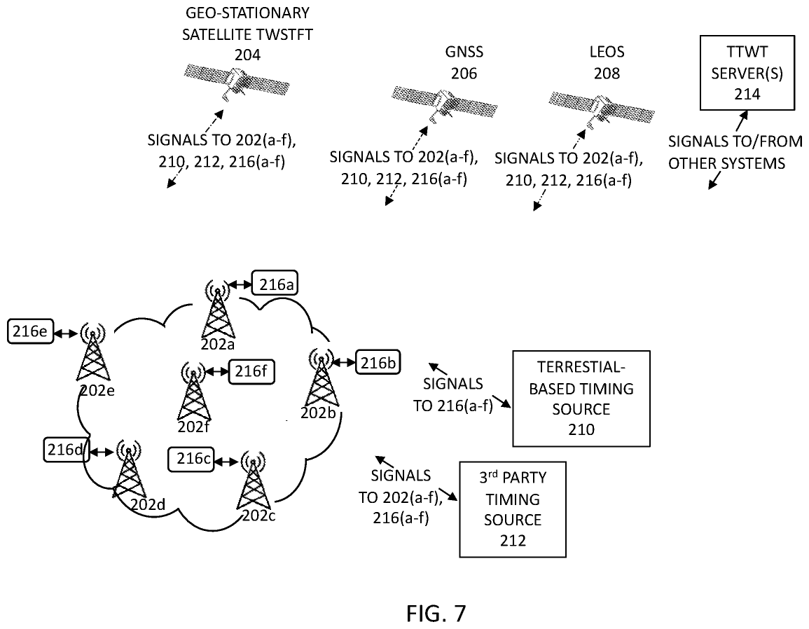

FIG. 7 is a schematic of a position, navigation, and timing (PNT) network with a timing validation service (TMV) at every node, in accordance with some embodiments. In this scenario, there are a plurality of TMVs 216, and each TMV 216 is located at a respective beacon 202. This architecture is costly because the timing distribution relies on dedicated fiber links but offers advantages such as high bandwidth, low latency, immunity to electromagnetic interference, and long-distance transmission capabilities.

For example, TMV 216a corresponds to beacon 202a, TMV 216b corresponds to beacon 202b . . . . TMV 216n corresponds to beacon 202n. Method 300 of FIG. 3 may be implemented where each TMV 216 (e.g., TMV 216a-f) receives a first timing measurement and a first delay time from the terrestrial-based timing source 210 (e.g., first node) having a first receiver and a first local clock. The first receiver receives a first signal of a plurality of signals from a transmitter at a source, and the first signal has an associated first time. The source may be the geo-stationary satellite 204, GNSS 206, LEOS 208, or third-party timing source 212. The first time associated with a first signal is compared to the first local clock time associated with the terrestrial-based timing source 210 (e.g., the first node) and a first timing measurement is generated.

Each TMV 216 receives a second timing measurement and a second delay time from the corresponding beacon 202. For example, the beacon 202a is a second node of a plurality of nodes in the network 200 having a second receiver and a second local clock. The second receiver receives a second signal of a plurality of signals from a transmitter at a source, and the second signal has an associated second time. The source may be the geo-stationary satellite 204, GNSS 206, LEOS 208, or third-party timing source 212. The second time associated with a second signal is compared to the second local clock time at the beacon 202a (e.g., the second node) and a second timing measurement is generated.

The first delay time and the second delay time are also generated as described herein. Then, each TMV generates a correction factor time based on the first timing measurement, the first delay time, the second timing measurement, and the second delay time, and transmits the correction factor time to the corresponding beacon 202. The corresponding beacon 202 adjusts its local clock by applying the correction factor to the local clock time. In this way, each beacon 202 of the network in FIG. 7 has traceable time and in some embodiments, can wirelessly broadcast its time to nearby receivers listening to that beacon.

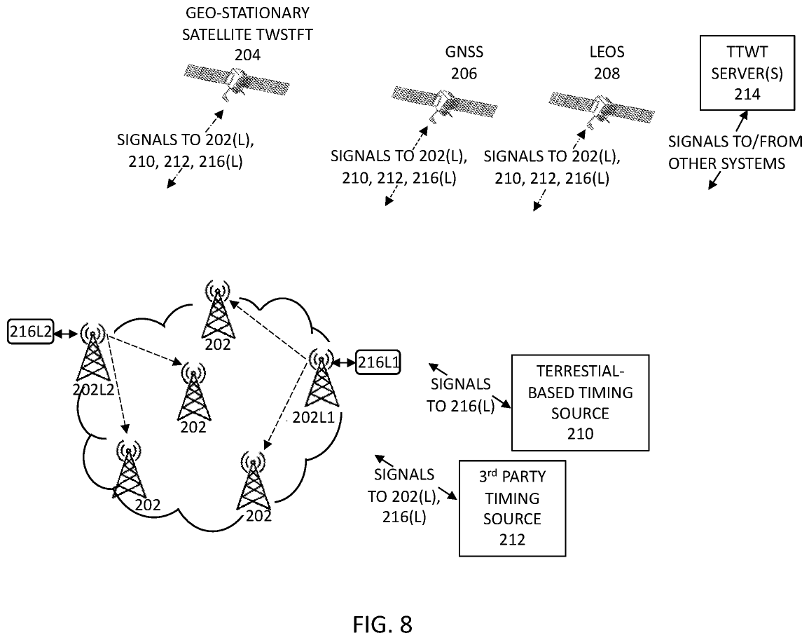

FIG. 8 is a schematic of a position, navigation, and timing (PNT) network with a timing validation service (TMV) at two leader nodes, in accordance with some embodiments. The architecture as shown reduces the number of nodes that require fiber timing service for traceable timing services, thus reducing cost. Rather than a TMV at every node, a first TMV 216L1 is at a first leader beacon 202L1 and a second TMV 216L2 is at a second leader beacon 202L2. In other examples, there may be only one TMV corresponding to one leader beacon 202L1 as shown in FIG. 2. In further examples, there may be a TMV 216 at other beacons 202 in the network 200 in a one-to-one ratio. However, generally, reducing the number of TMVs 216 in the network 200 diminishes the necessity for a dedicated fiber timing service, consequently lowering costs.

Referring to FIG. 8, method 300 for traceable timing services as described herein can be implemented for TMV 216L1 and corresponding leader beacon 202L1, and for TMV 216L2 and corresponding leader beacon 202L2. Once the respective correction factor time is generated, time validation can be performed. Various methods can be employed to transfer time between nodes, for example, two-way time transfer between the nodes, or common view time transfer techniques.

Two-way time transfer can also be used to derive an additional timing source input at any node from a remote fiber access node. This timing source can be used to detect an anomaly in another timing source at the node. Another alternative is common view signals at two nodes to transfer time wirelessly between them (as disclosed in U.S. Pat. No. 8,130,141). The common view signals usable for this purpose can be any transmission that has timing markers (for example, identifiable bit transitions/patterns) and is hearable at the two nodes even if the common view signals are not phase-aligned to any timing scale. If another quality time source is available for some portion of the time at the common view nodes, the static component of the multipath of the common view source-to-node channels could be calibrated out as well.

Satellite systems provide timing service either directly or indirectly through measurements on signals transmitted by such satellites and may be the geo-stationary satellite 204, GNSS 206, LEOS 208, or third-party timing source 212, among others. For example, GNSS measurements obtained from standalone GNSS receivers in one node having a TMV service can be compared with the GNSS measurements at a second node using common view GNSS measurement techniques to transfer time between the first node having TMV 216 and the second node without a TMV 216. The TMV 216 may detect and flag local GNSS outages/anomalies at the second node. This reduces the requirement of the TMV 216 being required at all nodes. In a broader example, a first set of measurements may be received from a satellite system at one node having a TMV 216 and then compared with a second set of measurements at a second node using common view time transfer techniques to determine local satellite anomalies at the second node without the need for TMV 216 at the second node.

This hybrid approach optimizes deployment and cost while minimizing the exposure to satellite vulnerabilities. Moreover, by using the hybrid architecture for traceable timing services, expensive methods, distribution, and deployment associated with nodes utilizing fiber timing access links is balanced with lower cost solutions, such as nodes utilizing satellites for timing synchronization, while being resilient to threats, hazards and/or disruptions to the satellite-based timing service.

In a non-limiting example, referring to FIG. 2, a plurality of nodes—beacons 202—receive timing information from a multiplicity of timing sources. Method 300 is implemented for the signal with timing information from the GNSS 206 source, specifically GPS. The correction factor time is generated by the TMV 216 at leader beacon 202L1. The characteristics of the timing measurements and correction factor time are analyzed dynamically. Because the correction factor time is not within the predetermined correction threshold, an anomaly is detected. The other beacons 202 in the network rely on the GPS source and the detected anomaly may be indicative of a GPS spoofing or jamming event. Once the anomalous condition is detected, the leader beacon 202L1 may notify the other beacons 202 in the network relying on GPS not to utilize the affected timing source. In some embodiments, the beacons 202 may switch to an alternative timing sources such as a rubidium clock not disciplined by GPS or two-way timing transfer methods between wireless transmission points. The beacons 202 nodes may also report the anomalous conditions to users or customers of the timing system.

Positioning systems and methods associated with terrestrial positioning networks are described in co-assigned U.S. Pat. No. 8,130,141, issued Mar. 6, 2012, and U.S. Pat. No. 9,057,606, issued Jun. 16, 2015, incorporated by reference herein in their entirety for all purposes. Two-way time transfer techniques within terrestrial positioning networks are described in co-assigned U.S. Pat. No. 9,967,845, issued May 8, 2018, and incorporated by reference herein in its entirety for all purposes. Combining Purpose-Built Location System with Signals of Opportunity is described in co-assigned U.S. application Ser. No. 18/495,490, filed Oct. 26, 2023, and incorporated by reference herein in its entirety for all purposes. Systems and Methods for Assured Time Synchronization of an RF Beacon are described in co-assigned U.S. Pat. No. 10,231,201, issued Mar. 12, 2019, and incorporated by reference herein in its entirety for all purposes.

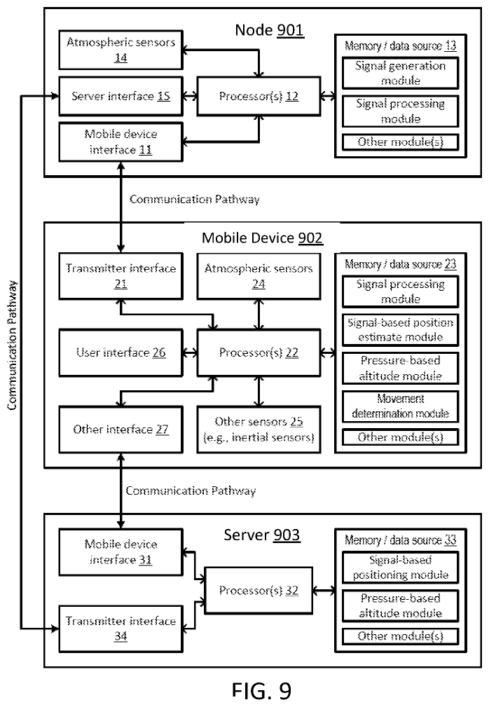

FIG. 9 provides implementation details of an example transmitter, mobile device, and server introduced in FIG. 1, in accordance with some embodiments. FIG. 9 illustrates components of an example node 901 (e.g., beacons, terrestrial transmitters, and/or transceivers; one of the nodes 110a-c), an example mobile device 902 (e.g., one of the mobile devices 120a-b), and an example server 903 (e.g., any one of the servers 130). Examples of communication pathways are shown by arrows between components. The components shown in FIG. 9 are operable to perform all or a portion of the method 300 and method 400.

By way of example in FIG. 9, each of the nodes 901 may include a mobile device interface 11 for exchanging information with a mobile device (e.g., antenna(s) and RF front-end components known in the art or otherwise disclosed herein); one or more processor(s) 12; memory/data source 13 for providing storage and retrieval of information and/or program instructions; atmospheric sensor(s) 14 for measuring environmental conditions (e.g., pressure, temperature, humidity, other) at or near the transmitter; a server interface 15 for exchanging information with a server (e.g., an antenna, a network interface, or other); and any other components known to one of ordinary skill in the art. The memory/data source 13 may include a memory storing software modules with executable instructions, and the processor(s) 12 may perform different actions by executing the instructions from the modules, including (i) performance of a part or all of the methods as described herein or otherwise understood by one of skill in the art as being performable at the transmitter; (ii) generation of positioning signals for transmission using a selected time, frequency, code, and/or phase; (iii) processing of signals received from the mobile device or another source; or (iv) other processing as required by operations described in this disclosure. Signals generated and transmitted by a transmitter may carry different information that, once determined by a mobile device or a server, may identify the following: the transmitter; the transmitter's position; environmental conditions at or near the transmitter; and/or other information known in the art. The atmospheric sensor(s) 14 may be integral with the transmitter, or separate from the transmitter and either co-located with the transmitter or located in the vicinity of the transmitter (e.g., within a threshold amount of distance).

By way of example in FIG. 9, the mobile device 902 may include a transmitter interface 21 for exchanging information with a transmitter (e.g., an antenna and RF front-end components known in the art or otherwise disclosed herein); one or more processor(s) 22; memory/data source 23 for providing storage and retrieval of information and/or program instructions; atmospheric sensor(s) 24 (such as barometers and temperature sensors) for measuring environmental conditions (e.g., pressure, temperature, other) at the mobile device; other sensor(s) 25 for measuring other conditions (e.g., inertial sensors for measuring movement and orientation); a user interface 26 (e.g., display, keyboard, microphone, speaker, other) for permitting a user to provide inputs and receive outputs; another interface 27 for exchanging information with the server or other devices external to the mobile device (e.g., an antenna, a network interface, or other); and any other components known to one of ordinary skill in the art. A GNSS interface and processing unit (not shown) are contemplated, which may be integrated with other components (e.g., the interface 21 and the processors 22) or a standalone antenna, RF front end, and processors dedicated to receiving and processing GNSS signaling. The memory/data source 23 may include a memory (e.g., a data storage module) storing software modules with executable instructions, and the processor(s) 22 may perform different actions by executing the instructions from the modules, including (i) performance of a part or all of the methods as described herein or otherwise understood by one of ordinary skill in the art as being performable at the mobile device; (ii) estimation of an altitude of the mobile device based on measurements of pressure from the mobile device and transmitter(s), temperature measurement(s) from the transmitter(s) or another source, and any other information needed for the computation); (iii) processing of received signals to determine position information (e.g., times of arrival or travel time of the signals, pseudoranges between the mobile device and transmitters, transmitter atmospheric conditions, transmitter and/or locations or other transmitter information); (iv) use of position information to compute an estimated position of the mobile device; (v) determination of movement based on measurements from inertial sensors of the mobile device; (vi) GNSS signal processing; or (vii) other processing as required by operations described in this disclosure.

By way of example in FIG. 9, the server 903 may include a TMV 216 or mobile device interface 31 for exchanging information with a mobile device (e.g., an antenna, a network interface, or other); one or more processor(s) 32; memory/data source 33 for providing storage and retrieval of information and/or program instructions; a transmitter interface 34 for exchanging information with a transmitter (e.g., an antenna, a network interface, or other); and any other components known to one of ordinary skill in the art. The memory/data source 33 may include a memory storing software modules with executable instructions, and the processor(s) 32 may perform different actions by executing instructions from the modules, including (i) performance of a part or all of the methods as described herein or otherwise understood by one of ordinary skill in the art as being performable at the server; (ii) estimation of an altitude of the mobile device; (iii) computation of an estimated position of the mobile device; or (iv) other processing as required by operations described in this disclosure. Steps performed by servers as described herein may also be performed on other machines that are remote from a mobile device, including computers of enterprises or any other suitable machine.

Certain aspects disclosed herein relate to estimating the positions of mobile devices—e.g., where the position is represented in terms of latitude, longitude, and/or altitude coordinates; x, y, and/or z coordinates; angular coordinates; or other representations. Various techniques to estimate the position of a mobile device can be used, including trilateration, which is the process of using geometry to estimate the position of a mobile device using distances traveled by different “positioning” (or “ranging”) signals that are received by the mobile device from different beacons (e.g., terrestrial transmitters and/or satellites). If position information like the transmission time and reception time of a positioning signal from a beacon is known, then the difference between those times multiplied by the speed of light would provide an estimate of the distance traveled by that positioning signal from that beacon to the mobile device. Different estimated distances corresponding to different positioning signals from different beacons can be used along with position information like the locations of those beacons to estimate the position of the mobile device. Positioning systems and methods that estimate the position of a mobile device (in terms of latitude, longitude, and/or altitude) based on positioning signals from beacons (e.g., transmitters, and/or satellites) and/or atmospheric measurements are described in co-assigned U.S. Pat. No. 8,130,141, issued Mar. 6, 2012, and U.S. Pat. No. 9,057,606, issued Jun. 16, 2015, incorporated by reference herein in its entirety for all purposes. It is noted that the term “positioning system” may refer to satellite systems (e.g., Global Navigation Satellite Systems (GNSS) like GPS, GLONASS, Galileo, and Compass/Beidou), terrestrial transmitter systems, and hybrid satellite/terrestrial systems.

Reference has been made in detail to embodiments of the disclosed invention. Each example has been provided by way of explanation of the present technology, not as a limitation of the present technology. In fact, while the specification has been described in detail with respect to specific embodiments of the invention, it will be appreciated that those skilled in the art, upon attaining an understanding of the foregoing, may readily conceive of alterations to, variations of, and equivalents to these embodiments. For instance, features illustrated or described as part of one embodiment may be used with another embodiment to yield a still further embodiment. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only and is not intended to limit the invention.

What is claimed is:

1. A method, comprising:
receiving, by a timing validation service (TMV) from a first receiver at a first node, a first delay time and a first timing measurement, the first timing measurement generated by comparing a first time associated with a first signal to a first local clock time associated with the first node, the first signal being of a plurality of signals transmitted by a transmitter at a source, wherein each signal of the plurality of signals has an associated time;
receiving, by the TMV from a second receiver at a second node of a plurality of nodes in a network, a second delay time and a second timing measurement, the second timing measurement generated by comparing a second time associated with a second signal to a second local clock time at the second node, the second signal being of the plurality of signals transmitted by the transmitter at the source;
generating, by the TMV, a correction factor time based on the first timing measurement, the first delay time, the second timing measurement, and the second delay time; and
transmitting, by the TMV to the second node, the correction factor time.

2. The method of claim 1, wherein:
the first delay time is a first propagation delay based on a position of the transmitter at the source and a position of a first receiver antenna at the first node; and
the second delay time is a second propagation delay based on the position of the transmitter at the source and a position of a second receiver antenna at the second node.

3. The method of claim 1, wherein the first delay time and the second delay time further comprise a respective processing delay time and a respective implementation delay time.

4. The method of claim 1, wherein the source is a satellite-based position, navigation, timing (PNT) network including one or more of a geo-stationary satellite, Global Navigation Satellite System (GNSS), Low-Earth Orbiting Satellite (LEOS), or terrestrial-based timing source.

5. The method of claim 1, wherein the second receiver is a beacon or listening device of a purpose-built terrestrial PNT system.

6. The method of claim 1, further comprising:
comparing, by the TMV, the correction factor time to a predetermined correction threshold; and
adjusting, by the second receiver, the second local clock time by applying the correction factor time to the second local clock time when the correction factor time is within a predetermined correction threshold.

7. The method of claim 6, further comprising:
before the adjusting of the second local clock time with the correction factor time, determining a first estimated position of a mobile device; and
after the adjusting of the second local clock time with the correction factor time, determining a second estimated position of the mobile device;
wherein the second estimated position of the mobile device is a more accurate position as compared to the first estimated position of the mobile device.

8. The method of claim 6, further comprising:
notifying, by the second receiver, a third receiver at a third node of the plurality of nodes in the network, of the correction factor time; and
adjusting, by the third receiver, a third local clock time at the third node by applying the correction factor time to the third local clock time.

9. The method of claim 8, wherein the notifying is via a side communication channel or via a beacon data transmission.

10. The method of claim 1, further comprising:
detecting, by the TMV, an anomaly, the anomaly being i) a loss of the second signal, ii) a discontinuity in the second signal, or iii) the correction factor time exceeds a predetermined correction threshold.

11. The method of claim 10, further comprising:
in response to the anomaly being the loss of the second signal, not utilizing by the second receiver, the associated time of the plurality of signals from the source.

12. The method of claim 11, further comprising:
notifying, by the second receiver, a third receiver at a third node of the plurality of nodes in the network of the anomaly;
not utilizing by the third receiver, the associated time of the plurality of signals from the source; and
utilizing, by the third receiver, an associated time of the plurality of signals from an alternative transmitter at an alternative source, the alternative transmitter configured to transmit the plurality of signals to the third receiver.

13. The method of claim 12, wherein the notifying is via a side communication channel or via a beacon data transmission.

14. The method of claim 12, wherein the alternative source is a two-way time transfer method or a highly stable, precise timing source including an atomic clock, hydrogen maser clock, optical clock or quartz crystal oscillator.

15. The method of claim 10, further comprising:
in response to the anomaly being the discontinuity in the second signal, not utilizing by the second receiver, the associated time of the plurality of signals from the source, or utilizing by the second receiver, the associated time of the plurality of signals from the source with caution.

16. The method of claim 15, further comprising:
notifying, by the second receiver, a third receiver at a third node of the plurality of nodes in the network of the anomaly;
not utilizing by the third receiver, the associated time of the plurality of signals from the source; and
utilizing, by the third receiver, an associated time of the plurality of signals from an alternative transmitter at an alternative source, the alternative transmitter configured to transmit the plurality of signals to the third receiver.

17. The method of claim 10, further comprising:
in response to the anomaly of the correction factor time exceeding the predetermined correction threshold, not utilizing by the second receiver, the associated time of the plurality of signals from the source.

18. The method of claim 17, further comprising:
notifying, by the second receiver, a third receiver at a third node of the plurality of nodes in the network, of the anomaly;
not utilizing by the third receiver, the associated time of the plurality of signals from the source; and
utilizing, by the third receiver, an associated time of the plurality of signals from an alternative transmitter at an alternative source, the alternative transmitter configured to transmit the plurality of signals to the third receiver.

19. The method of claim 18, wherein the notifying is via a side communication channel or via a beacon data transmission.

20. The method of claim 18, wherein the alternative source is a two-way time transfer method or a highly stable, precise timing source including an atomic clock, hydrogen maser clock, optical clock or quartz crystal oscillator.
